(19) United States
(12) Patent Application Publication
(10) Pub. No.: US 2026/0212513 A1
(43) Pub. Date: Jul. 23, 2026

(54) ELECTRONIC DEVICE, METHOD AND NON-TRANSITORY COMPUTER-READABLE MEDIUM FOR OBJECT TRACKING

(71) Applicant: National Central University, Taoyuan City (TW)

(72) Inventors: Tsung-Han TSAI, Taoyuan City (TW); Chun-Lin LEE, Taoyuan City (TW)

(21) Appl. No.: 19/222,988

(22) Filed: May 29, 2025

(30) Foreign Application Priority Data
Jan. 22, 2025 (TW) 114102739

(51) Int. Cl. G06T 7/246; G06T 5/20; G06T 7/50; G06T 7/73; G06V 10/44; G06V 10/764; G06V 10/771; G06V 10/80

(52) U.S. Cl. CPC G06T 7/246; G06T 5/20; G06T 7/50; G06T 7/73; G06V 10/44; G06V 10/764; G06V 10/771; G06V 10/806

(57) ABSTRACT

An electronic device constructs and executes an object tracking network to confirm the location information of the target object in the area image. The object tracking network includes a feature extraction backbone network, a feature fusion network, and a prediction network. The feature extraction backbone network consists of two feature extractors with shared weights. The feature fusion network includes a plurality of cross-attention layers and a channel attention module, and each cross-attention layer includes two parallel cross-attention transformer modules. The object tracking network is a hybrid model that combines convolutional neural networks and Transformer architecture. By introducing the Transformer-based cross-attention mechanism and channel attention mechanism, the efficiency and accuracy of feature fusion are enhanced.

### PRIORITY

This application claims priority to Taiwan Patent Application No. 114102739 filed on Jan. 22, 2025, the entire contents of which are hereby incorporated by reference in their entirety.

### FIELD

The present invention relates to an electronic device, a method and a non-transitory computer-readable medium for object tracking. More specifically, the present invention relates to an electronic device, a method and a non-transitory computer-readable medium for object tracking based on a Siamese residual cross-attention network.

### BACKGROUND

Visual target tracking technology has significant applications in computer vision, including autonomous driving, surveillance systems, and unmanned aerial vehicles. Although deep learning technology has improved the performance of visual target tracking, with the increase of model parameters and computation, Real-Time tracking has become a big challenge for edge devices with limited resources.

Transformer Tracking (TransT) is a target tracking algorithm based on Transformer architecture, which uses the attention mechanism of “Transformer” for modeling the complex relationships between the target and the surrounding environment to achieve more accurate target tracking. The main feature of TransT is that it usually adopts the structure of Siamese Network. That is, two identical networks are adopted to extract features of the target and the search area, and the two features are compared through the attention mechanism to locate the target. Because TransT completely adopts the feature fusion network based on the attention mechanism of the Transformer architecture and not only one layer of cross-attention mechanism (CFA) but also self-attention mechanism (ECA) are used, the amount of parameters and computation of the whole model are enormous, which makes real-time inference difficult. This problem becomes more obvious when this mechanism is applied to edge devices with relatively limited computing resources.

Accordingly, an urgent technical problem to be solved in the art is to provide a visual target tracking solution that reduces the amount of parameters and computation and meanwhile improves the accuracy as compared to the TransT scheme.

### SUMMARY

To this end, the present invention proposes a hybrid model that integrates the convolutional neural network (CNN) and the “Transformer” architecture. By introducing a cross-attention mechanism and a channel attention mechanism based on “Transformer”, the present invention enhances the efficiency and accuracy of feature fusion and combines it with a depth estimation network.

More specifically, in order to at least solve the above technical problems, the present invention provides an electronic device for object tracking. The electronic device may comprise a storage and a processor. The storage may be configured to store an area image, a target image and an object tracking network. The processor is electrically connected with the storage and may be configured to construct and execute the object tracking network to confirm a piece of position information of an object represented by the target image in the area image. The object tracking network may comprise a feature extraction backbone network, a feature fusion network and a prediction network. The feature extraction backbone network may comprise two feature extractors with shared weights, and the two feature extractors may be respectively configured to extract features according to the area image and the target image so as to generate a target feature map and an area feature map. The feature fusion network may include a plurality of cross-attention layers and a channel attention module. Each cross-attention layer may include two parallel cross-attention transformer modules, and in the feature fusion network, both the target feature map and the area feature map may be input into the two cross-attention transformer modules. The feature fusion network may be configured to: perform a depthwise cross correlation operation on the target feature map and the area feature map that have been refined by the plurality of cross-attention layers, thereby generating a response map. Moreover, the feature fusion network may be further configured to generate a channel attention vector according to the response map through the channel attention module. In addition, the feature fusion network may be further configured to perform an element-wise multiplication operation on the channel attention vector and the response map to generate a weighted response map. The prediction network may be configured to generate the position information according to the weighted response map.

In order to at least solve the above technical problems, the present invention further provides an object tracking method. The object tracking method may be executed by an electronic device, and may at least include a step of “constructing an object tracking network” and a step of “executing the object tracking network to confirm the position information of an object represented by the target image in the area image”. The object tracking network may comprise a feature extraction backbone network, a feature fusion network and a prediction network. The feature extraction backbone network may comprise two feature extractors with shared weights, and the two feature extractors may be respectively configured to extract features according to the area image and the target image so as to generate a target feature map and an area feature map. The feature fusion network may include a plurality of cross-attention layers and a channel attention module. Each cross-attention layer may include two parallel cross-attention transformer modules, and in the feature fusion network, both the target feature map and the area feature map may be input into the two cross-attention transformer modules. The feature fusion network may be configured to: perform a depthwise cross correlation operation on the target feature map and the area feature map that have been refined by the plurality of cross-attention layers, thereby generating a response map. Moreover, the feature fusion network may be further configured to generate a channel attention vector according to the response map through the channel attention module. In addition, the feature fusion network may be further configured to perform an element-wise multiplication operation on the channel attention vector and the response map to generate a weighted response map. The prediction network may be configured to generate the position information according to the weighted response map.

In order to at least solve the above technical problems, the present invention further provides a non-transitory computer-readable medium storing instructions that, when executed by a processor, perform the object tracking method described above.

Generally speaking, the present invention provides a novel, efficient and accurate visual target tracking network architecture based on Transformer, which consists of a feature extraction backbone network, a feature fusion network integrating a Cross-Attention Transformer mechanism and a channel attention mechanism, and a predictive classification regression network. More specifically, the present invention introduces the concept of cross-attention mechanism, and through the characteristics of attention mechanism, the unique information of two types of features can be exchanged in two feature maps, so as to improve the feature representation ability of network extraction. In addition, the present invention also introduces Channel-Attention Depthwise Cross Correlation, which enhances feature representation and effectively fuses features through simple modules without reducing the inference speed. Furthermore, the present invention integrates the cross-attention mechanism and the Channel-Attention Depthwise Cross Correlation to realize the feature fusion network, and finally obtains better prediction results while achieving real-time model performance.

The above content provides a basic description of the present invention, including the technical problems solved, the technical means adopted and the technical effects achieved by the present invention, and various embodiments of the present invention will be further illustrated hereinafter.

### BRIEF DESCRIPTION OF THE DRAWINGS

FIG. 1 illustrates an electronic device for object tracking according to one or more embodiments of the present invention.

FIG. 2 illustrates the overall architecture of an object tracking network according to one or more embodiments of the present invention.

FIG. 3 illustrates the operation of a cross-attention layer in the object tracking network shown in FIG. 2.

FIG. 4 illustrates the operation of a channel attention module in the object tracking network shown in FIG. 2.

FIG. 5 illustrates the overall architecture of an object tracking network and a depth estimation network according to one or more embodiments of the present invention.

FIG. 6 illustrates an object tracking method according to one or more embodiments of the present invention.

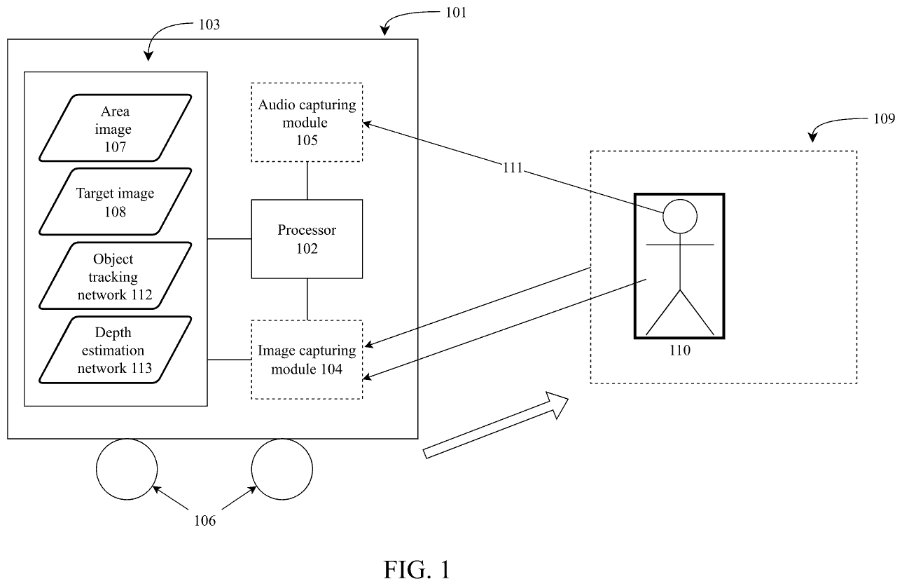

The contents shown in FIG. 1 to FIG. 6 are only exemplary examples for explaining the embodiments of the present invention, and are not intended to limit the scope claimed in the present invention.

### DETAILED DESCRIPTION

The following example embodiments are not intended to limit the claimed invention to a specific environment, application, structure, process, or situation. In the attached drawings, elements unrelated to the claimed invention are omitted from depiction. In the attached drawings, dimensions of and dimensional scales among individual elements are provided only as exemplary examples, and are not intended to limit the claimed invention. Unless otherwise specified, same element symbols in the following description may refer to the same elements.

The terminologies described here are only for ease of description of contents of the embodiments, and are not intended to limit the claimed invention. Unless otherwise specified clearly, the singular form “a” or “an” shall be deemed to include the plural form as well. The terms such as “comprising”, “including” and “having” are used to specify the existence of features, integers, steps, operations, elements, components and/or groups stated after the terms, but do not exclude the existence or addition of one or more other additional features, integers, steps, operations, elements, components and/or groups and so on. The term “and/or” is used to indicate any one or all combinations of one or more associated items enumerated. When terms such as “first”, “second” and “third” are used to describe elements, they are only intended to distinguish these described elements instead of limiting these elements. Therefore, for example, an element that is the first in sequence may also be named as a “second element” without departing from the spirit or scope of the claimed invention.

A first embodiment of the present invention is an electronic device for object tracking. Referring to FIG. 1, there is shown an electronic device 101 for object tracking, which may be configured to identify the position of a specific object (such as a person, a pet, a car, a flying object, etc.) in an image as a whole, and then track the position of the object in a continuous image stream. In some embodiments, in addition to identifying the location of an object in various images, the electronic device 101 may also be configured to physically track the object by moving in the actual field, and for example be implemented as a service robot, a robot pet, an automated trolley or the like.

The electronic device 101 may basically comprise at least a processor 102 and a storage 103. In some embodiments, the electronic device 101 may further comprise an image capturing module 104, an audio capturing module 105 and/or a transport module 106. The processor 102 may be electrically connected with the storage 103, the image capturing module 104, the audio capturing module 105 and the transport module 106, and the image capturing module 104 may also be electrically connected with the storage 103. The electrical connection between the above-mentioned elements may be direct (i.e., the elements are connected to each other without other elements) or indirect (i.e., the elements are connected to each other via other elements).

The processor 102 may be a programmable special integrated circuit that is capable of operating, storing, outputting/inputting or the like, and may accept and process various coded instructions so as to perform various logical operations and arithmetic operations and output corresponding operation results. The processor 102 may be programmed to interpret various instructions and execute various tasks or programs to complete various processes described herein. For example, the processor 102 may comprise a Central Processing Unit (CPU), a Graphics Processing Unit (GPU), a Digital Signal Processor (DSP), a Microprocessor, and/or a Microcontroller or the like. The storage 103 may be used to store data generated by the electronic device 101, data transmitted from external devices, and/or data generated by users through input/output elements (such as combinations of a keyboard, a mouse, a touch panel, a display and other elements). For example, the storage 103 may comprise a primary memory (which is also called a main memory or an internal memory), and the processor 102 may directly read instruction sets stored in the primary memory, and execute these instruction sets if needed.

The storage 103 may further comprise a secondary memory (which is also called an external memory or an auxiliary memory) which can transmit data stored to the primary memory through a data buffer. The secondary memory may be for example but not limited to a hard disk, an optical disk or other storage mediums. The storage 103 may also comprise a tertiary memory, e.g., a pluggable storage device or a cloud hard disk. The storage 103 may comprise the primary memory, the secondary memory and/or the tertiary memory according to different requirements.

The image capturing module 104 may be a collection of elements with the image shooting function, which may at least comprise a lens, a photosensitive element, an image processing unit and a control circuit for the above elements. In some embodiments, the image processing operation performed by the image processing unit may also be performed by the processor 102.

The image capturing module 104 may be configured to shoot and generate an area image 107 and a target image 108. The area image 107 may be an image of a field 109 in which object tracking is to be performed. The target image 108 may be a close-up image containing an object 110 (such as a person, a pet, a car, a flying object or the like described above) of which the position is to be tracked, and it may be a partial image captured from the area image 107 when the area image 107 is captured, or an image captured separately by the user. In addition, in the embodiment with a depth estimation network (details of which will be described later), the lens used by the image capturing module 104 may be a general RGB lens, and it is unnecessary to use an expensive RGB depth (RGBD) lens with the depth measurement function.

The audio capturing module 105 may be a collection of elements with sound reception function that convert sound into signals, and it may at least comprise a microphone (which may be in the form of for example a sound reception hole embedded in the device or a physical microphone externally hung on the device) and a control circuit thereof. The audio capturing module 105 may be an element capable of identifying the direction of sound, such as a directional microphone, and the processor 102 may identify a specific voice command 111 through the audio capturing module 105 to confirm the orientation of the object 110 to be tracked. In the smart wake-up section, for example, the open-source speech recognition module CMU-Sphinx, which is a language recognition module suitable for large vocabulary and non-specific vocabulary, may be adopted to recognize wake-up words, without being limited thereto.

The transport module 106 may be a collection of elements with transport function to enable displacement, expansion and contraction and/or rotation of the electronic device 101, and it may at least comprise mechanisms corresponding to the above-mentioned modes of movement and the control circuit thereof. When the mode of movement is displacement, the transport module 106 may have a structure in the form of, for example, wheels, tracks, slide rails or the like. When the mode of movement is expansion and contraction, the transport module 106 may have a structure in the form of, for example, a telescopic arm, a telescopic ladder/frame or the like. When the mode of movement is rotation, the transport module 106 may have a structure in the form of, for example, a rotating shaft, a base, a rotary table or the like. The corresponding structure and control circuit thereof that the transport module 106 can comprise shall be readily appreciated by those of ordinary skill in the art to which the present invention belongs according to the above-mentioned modes of movement, and thus will not be further described herein. In some embodiments, when the processor 102 identifies the specific voice command 111 and confirms the orientation of the object 110 through the audio capturing module 105 as described above, the transport module 106 may enable the electronic device 101 (or at least the image capturing module 104 therein) to move so that the image capturing module 104 faces the orientation of the object 110. The transport module 106 may also be configured to actually track and follow the position of the object 110.

The storage 103 may be configured to store at least the area image 107, the target image 108 and the object tracking network 112. Generally speaking, the object tracking network 112 may be configured to perform object tracking according to the area image 107 and the target image 108. The processor 102 may be configured to construct and execute the object tracking network 112 to confirm the position information of the object 110 represented by the target image 108 in the area image 107. In some embodiments, the location information may be presented in the form of boxes in the image and/or coordinate values in the image.

In some embodiments, the storage 103 may be further configured to store the depth estimation network 113, while the processor 102 may be further configured to construct and execute the depth estimation network 113. Generally speaking, the depth estimation network 113 may be configured to estimate depth information according to the area image 107. In these embodiments, the processor 102 may be further configured to construct and execute the depth estimation network 113 to further obtain details about the depth besides the position information generated by the object tracking network 112, so as to make the position determination result for the object 110 by the electronic device 101 and/or the actual moving mode of the electronic device 101 following the object 110 more delicate.

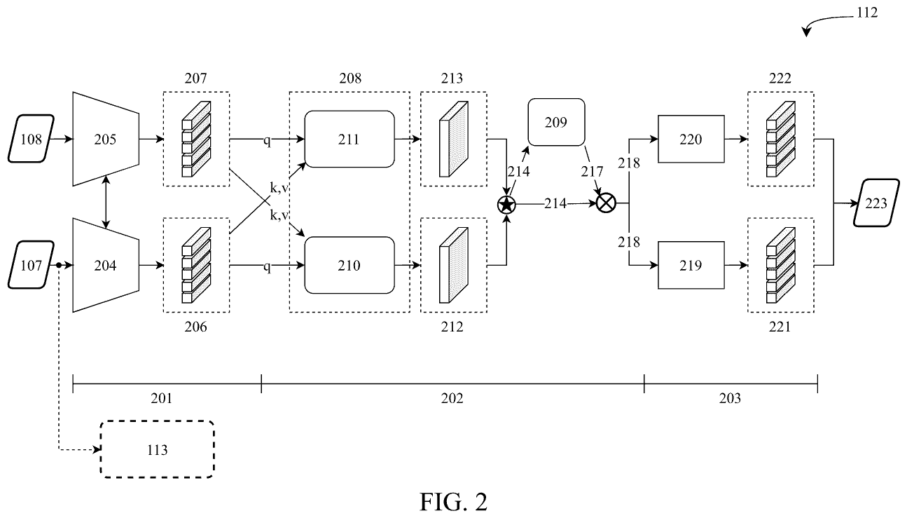

Referring to FIG. 2, there is shown relevant details of the object tracking network 112 shown in FIG. 1. The architecture of the object tracking network 112 is divided into three parts as a whole. The first part is a feature extraction backbone network 201, which presents the architecture of a Siamese network. The second part is a feature fusion network 202, which is composed of the architecture of Cross-Attention Transformer Module in combination with depthwise cross correlation operation, and in order to further enhance the target feature representation ability of the Response Map after cross correlation, the present invention also introduces the channel attention mechanism. The third part is a prediction network 203, which further predicts the response map into an accurate target position and size.

In view of the fact that the architecture based on Siamese network and the architecture based on Transformer have their own advantages and disadvantages in the visual target tracking task, the present invention attempts to extract their respective advantages from the architecture of both CNN-based and Transformer-based design directions, and thus draws lessons from the basic framework of Siamese network and CNN-Transformer-Based tracking method (i.e., TransT). More specifically, the object tracking network 112 of the present invention is based on three main constituent networks in the TransT architecture, namely, a feature extraction Backbone Network, a Feature Fusion Network and a prediction network (a Prediction Head Module).

As mentioned earlier, TransT completely adopts the feature fusion network based on the attention mechanism of Transformer architecture, and not only one layer of cross-attention mechanism (CFA) but also self-attention mechanism (ECA) are used, which makes the amount of parameters and computation of the whole model enormous and makes real-time inference difficult. In contrast, the architecture proposed by the present invention is inspired by the Cross-Attention Transformer (CAT) architecture, and at the same time, an efficient and accurate feature fusion network is introduced. CAT is the network architecture of One-Shot Object Detection, which aims to give an image with a category label, and then the model architecture needs to find out all objects with the same category label as the given category label in the input image. For example, if two images are taken as input, one is an image with a category label of horse and the other is an image to be detected, then as the output result of the model, the model may frame out objects with the category label of horse on the image to be detected through the image with the category label of horse.

After repeated experiments and induction, the inventors thought that such task idea actually has the same concept as visual target tracking, that is, searching for the most similar target object on the image to be detected through an image. Therefore, the present invention designs the feature fusion network by referring to the Cross-Attention Transformer mechanism used in the CAT architecture, and further considering the shortcomings of the TransT in the design of the feature fusion network described above, the object tracking network 112 of the present invention additionally adopts the Cross Correlation mechanism.

Generally speaking, the input information of the object tracking network 112 is two images, one is the target image 108 (i.e., Iₜ∈ [symbol] ) and the other is the area image 107 to be tracked (i.e., Iₛ∈ [symbol] ). Firstly, regarding the first part mentioned above, the feature extraction backbone network 201 may respectively map and convert the input images into feature maps with higher feature dimensions

$$( {f}_{t} ∈ {ℝ}^{d \times {H}_{t}^{′} \times {W}_{t}^{′}} , {f}_{s} ∈ {ℝ}^{d \times {H}_{s}^{′} \times {W}_{s}^{′}} ) .$$

For example, it may be set as follows:

$$\begin{matrix}{H}_{t} , {W}_{t} = 128 \\ {H}_{s} , {W}_{s} = 256 \\ {H}_{t}^{′} = {W}_{t}^{′} = \frac{{H}_{t}}{8} \\ {H}_{s}^{′} = {W}_{s}^{′} = \frac{{H}_{s}}{8} \\ d = 1024\end{matrix}$$

The Backbone Network is the foundation of the whole task in the field of computer vision, and it is generally used as a feature extractor of input images, common examples of which include AlexNet, GoogleNet and ResNet or the like. The feature maps generated by these networks are provided for use by subsequent connected networks, and the input RGB feature dimensions are mapped to higher-dimensional feature maps, most of which are trained on large-scale object classification data sets. Therefore, the overall network model parameters have strong adaptability to various tasks, and the present invention only needs to fine-tune the architecture to make it more suitable for its own tasks.

The object tracking network 112 comprises two feature extractors with shared weights, namely, a feature extractor 204 and a feature extractor 205. That is, an architecture similar to the Siamese network is adopted as the model feature extractor “@”. The feature extractor 204 and the feature extractor 205 may be respectively configured to extract features according to the area image 107 and the target image 108 to generate an area feature map 206 and a target feature map 207. The feature extractor 204 and the feature extractor 205 may specifically be, for example, but not limited to, a ResNet50 backbone network with two shared weights to process two input images in parallel respectively. ResNet50 is a variant of Residual Network, which is used to solve the degradation problem in deep network training.

The feature extractor 204 and the feature extractor 205 may map and convert the input information (i.e., two images of the area image 107 (Iₛ∈ [symbol] ) and the target image 108 (Iₜ∈ [symbol] )) into two feature maps with higher feature dimensions, i.e.,

$${f}_{s} ∈ {ℝ}^{d \times {H}_{s}^{′} \times {W}_{s}^{′}} and {f}_{t} ∈ {ℝ}^{d \times {H}_{t}^{′} \times {W}_{t}^{′}} ,$$

so as to enhance the feature representation ability of the target on the feature maps. The equation may be expressed as: fₜ, fₛ=φ(Iₜ),φ(Iₛ).

Next, regarding the second part mentioned above, the feature fusion network 202 generally may comprise a plurality of cross-attention layers (a cross-attention layer 208 is taken as an example in FIG. 2) and a channel attention module 209. The most significant (but not the only) difference between the present invention and the TransT lies in the architectural details of the feature fusion network 202. Feature Fusion Network is one of the key parts of the tracking framework proposed by the present invention, and it is also a major design focus of the visual target tracking task. The main function of feature fusion network is to effectively combine feature messages of the target image and the area image to be tracked, thereby improving the accuracy of target tracking. Generally speaking, the feature fusion network can integrate features from different levels, including low-level target contour and shape information and high-level semantic information. This multi-level feature fusion enables the model to understand various attributes of the target object more comprehensively, thus significantly enhancing the target tracking ability and further improving the robustness to the target. Therefore, in the face of challenges such as appearance change, illumination change and occlusion of the target, the fusion of multiple features can provide a more stable and reliable tracking foundation, so that the model can better adapt to these changes and maintain a stable tracking effect.

As mentioned above, the feature fusion network 202 may have the basic architecture of Transformer. However, because the input of the Transformer architecture is a one-dimensional sequence and there are too many information dimensions of the feature map that has been subjected to feature extraction before, this leads to a huge amount of calculation for the cross-attention mechanism of the feature fusion network 202. Therefore, before the feature fusion network 202, the processor 102 may first compress (e.g., to 256) the number of feature channels (e.g., 1024 features) by using a convolution kernel with a specific size (e.g., 1×1), and flatten the feature map in the HW spatial direction, thereby obtaining the target feature map

$$( {f}_{t}^{′} ∈ {ℝ}^{256 \times {H}_{t}^{′} \times {W}_{t}^{′}} )$$

and the area feature map

$$( {f}_{s}^{′} ∈ {ℝ}^{256 \times {H}_{s}^{′} \times {W}_{s}^{′}} )$$

with reduced dimensions, and inputting them into the cross-attention layer.

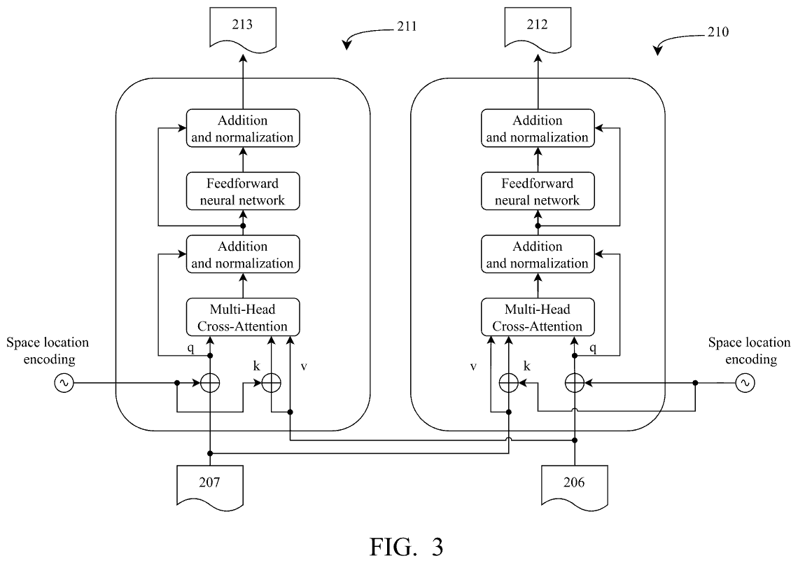

Next, referring to FIG. 3, there is shown relevant details of the cross-attention layer by taking the cross-attention layer 208 in FIG. 2 as an example. The present invention introduces a Cross-Attention Transformer Module (CATM) into the Transformer architecture. The cross-attention layer 208 may comprise two parallel cross-attention transformer modules, namely a cross-attention transformer module 210 and a cross-attention transformer module 211. In the feature fusion network 202, both the area feature map 206 and the target feature map 207 will be input into the cross-attention transformer module 210 and the cross-attention transformer module 211.

As shown in FIG. 3, each cross-attention transformer module adopts a dual-stream parallel processing architecture, and performs interactive feature search on the bidirectional correspondence relationships between the target feature map 207 and the area feature map 206 previously extracted by the backbone network, so that the two feature maps can exchange information with each other, thereby enhancing the representation ability of features similar to each other. The “q”, “k” and “v” shown in FIG. 2 and FIG. 3 represent feature parameters in the two feature maps.

Two parallel cross-attention transformer modules (such as the cross-attention transformer module 210 and the cross-attention transformer module 211 shown in FIG. 3) may simultaneously concentrate on extracting useful features with high similarity between two feature vectors, and may form a Cross-Attention Layer. The cross-attention layer may be connected in series for a plurality of times, such as but not limited to 4 times. This refers to the setting in the TransT model, that is, the Transformer architecture is repeated for 4 times. Two parallel cross-attention transformer modules in each cross-attention layer may perform Multi-Head Cross-Attention processing, addition and normalization, feedforward neural network and other processing on each feature parameter in the two feature maps, and finally generate the processed area feature map 212 and target feature map 213.

Next, in the feature fusion network 202, the processor 102 may perform a Depthwise Cross Correlation operation on the target feature map 213 and the area feature map 212 that have been refined by the plurality of cross-attention layers, thereby generating a response map 214. More specifically, the depthwise cross correlation operation may be expressed as a Cross Correlation operation for each corresponding channel of the area feature map 212 (Yₛ) with each channel of the target feature map 213 (Yₜ) as a convolution kernel, while “Yₜ” and “Yₛ” respectively represent the target template feature map and the area feature map to be searched that are refined by the cross-attention mechanism, and the equation may be expressed as: R=Yₛ*Yₜ.

In the above equation, “*” represents the depthwise cross correlation operation, and “R” represents the response map after the depthwise cross correlation. Because the subsequent prediction network predicts the precise location and size of the target according to the target response map, high-response channels are crucial for accurate prediction. The channel attention mechanism introduced by the present invention is exactly used to improve the channel attention in the response map, thereby improving the prediction accuracy.

The response map 214 may be provided to the channel attention module 209, and the channel attention module 209 may generate a channel attention vector according to the response map 214, and perform element-wise multiplication operation on the channel attention vector and the response map 214, thereby weighting the channel attention mechanism to the original feature map and thus generating a weighted response map.

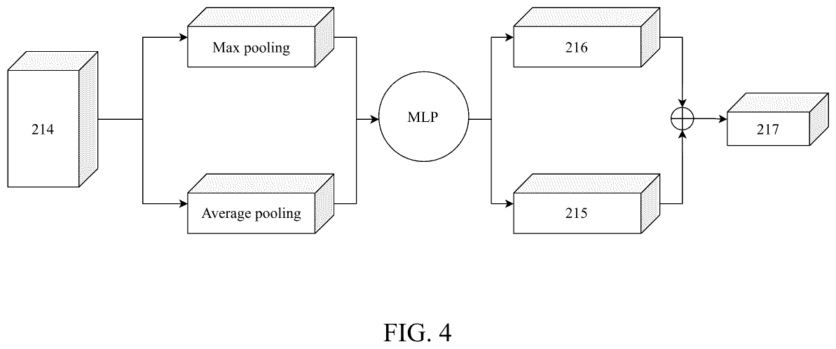

For more specific explanation, referring to FIG. 4 together, there is shown relevant details of the channel attention module 209 in FIG. 2. The channel attention module 209 may be divided into two branches to perform a Max-Pooling operation and an Average-Pooling operation respectively for the input response map 214. These two operations will generate two different feature space enhancement vectors, such as a feature space enhancement vector 215 and a feature space enhancement vector 216 shown in FIG. 4, and these two vectors will then be sent to a Multi-Layer Perceptron (MLP) network. The multi-layer perceptron network may comprise a hidden layer and a Sigmoid function. Finally, the channel attention module 209 may perform element-wise addition operation on the two enhanced feature vectors for integration to obtain the final result of the channel attention module 209, i.e., the Channel Attention Vector 217.

Next, the processor 102 may perform element-wise multiplication operation on the channel attention vector 217 and the response map 214 in the feature fusion network 202 to weight the channel attention mechanism to the original feature map, thereby obtaining a weighted response map 218. Through this mechanism, attention will be paid to more important channel features. The equation of the mechanism may be expressed as:

$$\begin{matrix}V = ML P ( A v g P o o l ( {F}_{i} ) ) + M L P ( M a x P o o l ( {F}_{i} ) ) \\ {F}_{i}^{′} = Matmul ( {F}_{i} , V )\end{matrix}$$

In the above equation, Fᵢ ∈ [symbol] is the input feature map,

$${F}_{i}^{′} ∈ {ℝ}^{d \times {H}^{′} \times {W}^{′}}$$

is the feature map enhanced by the channel attention mechanism, and V∈ [symbol] is the feature space enhancement vector.

For the third part described above, please continue to refer to FIG. 2. The prediction network (Prediction Head Module) 203 is the last sub-network of the target tracking network architecture proposed by the present invention, which consists of two branches: a Classification Branch 219 and a Regression Branch 220. Generally speaking, the prediction network 203 may be configured to generate the final position information according to the response map 218 output by the feature fusion network 202.

More specifically, each branch of the prediction network 203 may consist of three multi-layer perceptron (MLP) networks, the hidden layer dimension of which may be d, and it may have a ReLU excitation function. In order to predict the final position, the classification branch 219 may perform more accurate foreground and background target classification on the response map 218 fused by the feature fusion network and generate a classification vector 221 of H\hat{ }′W\hat{ }′×2, while the regression branch 220 may make a more subtle numerical regression prediction of the position and size of the target center point on the response map 218, and generate a regression vector 222 of H\hat{ }′W\hat{ }′×4, where “H\hat{ }” is H of the target response map, “W\hat{ }′” is W of the target response map, “2” represents the foreground and background classification label, and “4” represents four position and size values of the target “(x, y, w, h)” respectively. Finally, the processor 102 may obtain the tracking result 223 of the object tracking network 112 according to the predicted value.

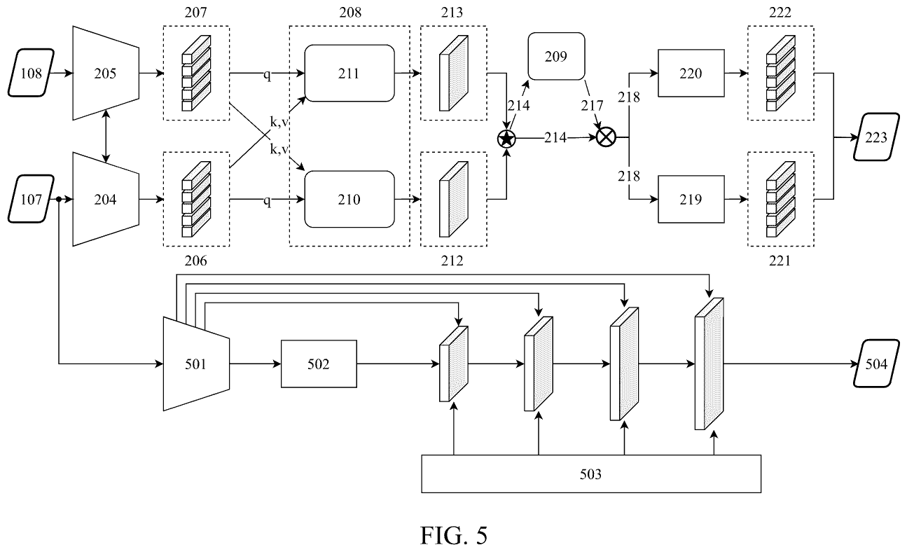

As mentioned above, in some embodiments, the storage 103 may also be configured to store the depth estimation network 113, and the processor 102 may also be configured to construct and execute the depth estimation network 113. Referring to FIG. 5, there is shown relevant details of the combination of the depth estimation network 113 and the object tracking network 112.

The depth estimation network 113 may comprise an encoder 501, a Non-Local Block (NLB) 502, and a decoder 503. The whole input of the depth estimation network 113 may also be the area image 107, that is, the continuous frames of image in which object tracking is to be performed. The networks of the object tracking network 112 and the depth estimation network 113 process the input images in parallel, and finally generate two outputs which are a tracking result 223 and a depth map 504 of the target respectively. In some embodiments, the processor 102 may control the moving direction of the transport module 106 (e.g., a working vehicle) according to the tracking result 223, and generate a control signal for controlling the transport module 106 to move forward or stop moving according to the depth map 504.

By introducing the non-local block into the depth estimation, the present invention breaks through the bottleneck of limited local features, and introduces global correlation information into the model to solve the problem of local features of traditional convolutional neural networks. The problem arises mainly because that CNN is limited by the local receptive field during feature extraction, as the features of one local block may not always provide sufficient information required for determining the true depth of the block. For example, when there are visually similar but spatially separated objects in the image, the correct depth cannot be reliably determined only from the local features, but NLB can perform global weighted fusion on the features at any position in the image to provide a comprehensive panoramic clue. In addition, in the present invention, the strategy of Squeeze-and-Excitation (SE) module is added in the working stage of the decoder 503 of the model to dynamically weight the importance of partial feature channels.

The present invention uses “Mobilenet-SSDv2” as the person detection network of the system, which is usually deployed on devices with limited hardware resources such as mobile phones, and has high accuracy performance. In the part of person tracking network, the present invention uses the above-mentioned visual target tracking network. In order to improve the real-time tracking ability of the model with little loss of accuracy performance, the present invention adopts “SiamCATR-MobilenetV2” with an efficient and lightweight backbone network; while in the depth estimation network, the present invention introduces a depth estimation network based on an encoder-decoder architecture with a Non-Local Decoder-Squeeze Excitation (NL-DSE) module.

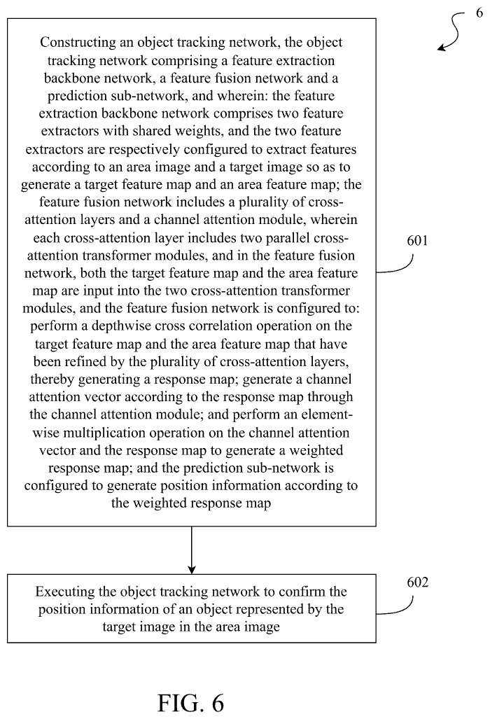

A second embodiment of the present invention is an object tracking method. Referring to FIG. 6, there is shown an object tracking method 6 according to one or more embodiments of the present invention. The object tracking method 6 may be executed by an electronic device (for example but not limited to the above-mentioned electronic device 101), and may comprise steps 601 and 602. Step 601 is as follows: constructing an object tracking network, which comprises a feature extraction backbone network, a feature fusion network and a prediction network, and wherein: the feature extraction backbone network comprises two feature extractors with shared weights, and the two feature extractors are respectively configured to extract features according to an area image and a target image so as to generate a target feature map and an area feature map; the feature fusion network includes a plurality of cross-attention layers and a channel attention module, wherein each cross-attention layer includes two parallel cross-attention transformer modules, and in the feature fusion network, both the target feature map and the area feature map are input into the two cross-attention transformer modules, and the feature fusion network is configured to: perform a depthwise cross correlation operation on the target feature map and the area feature map that have been refined by the plurality of cross-attention layers, thereby generating a response map; generate a channel attention vector according to the response map through the channel attention module; and perform an element-wise multiplication operation on the channel attention vector and the response map to generate a weighted response map; and the prediction network is configured to generate a piece of position information according to the weighted response map. Step 602 is as follows: executing the object tracking network to confirm the position information of an object represented by the target image in the area image.

In some embodiments, the object tracking method 6 may further comprise the following step: constructing and executing a depth estimation network to generate a piece of depth information according to the target image. Furthermore, in some embodiments, the depth estimation network may comprise an encoder, a non-local block, and a decoder, and the decoder comprises a Squeeze-and-Excitation module. Furthermore, in some embodiments, the object tracking method 6 may further comprise the following step: moving to follow the object represented by the target image, wherein the electronic device determines the moving direction according to the position information and determines the moving depth according to the depth information.

In some embodiments, the object tracking method 6 may further comprise the following steps: continuously receiving sound signals; identifying a preset voice command in the sound signals; moving to make an image capturing module of the electronic device face a source of the voice command after the voice command is identified; and photographing the source to generate the area image and the target image.

In some embodiments, for the object tracking method 6, the feature fusion network may take each channel of the target feature map refined by the plurality of cross-attention layers as a convolution kernel, and perform cross-correlation operation on each corresponding channel of the area feature map refined by the plurality of cross-attention layers to generate the response map after depthwise cross correlation.

In some embodiments, for the object tracking method 6, the feature fusion network may perform Max-Pooling operation and Average-Pooling operation respectively on the response map through the channel attention module to generate two different feature space enhancement vectors respectively, send the two vectors into a multi-layer perceptron network for enhancement, and then perform element-wise addition on the two feature space enhancement vectors that have been enhanced, thereby generating the channel attention vector.

In some embodiments, for the object tracking method 6, the multi-layer perceptron network may comprise a hidden layer and a Sigmoid function.

In some embodiments, for the object tracking method 6, the prediction network may comprise a classification branch and a regression branch, both of which are composed of three multi-layer perceptron networks. The classification branch performs foreground and background target classification on the target response map fused by the feature fusion network and generates a classification vector. The regression branch is configured to predict the position and size of a target center point and generate a regression vector containing the position information.

Each embodiment of the object tracking method 6 basically corresponds to a certain embodiment of the electronic device 101. Therefore, all the corresponding embodiments of the object tracking method 6 can be fully appreciated and realized by those of ordinary skill in the art simply with reference to the above description of the electronic device 101, even though not all the embodiments of the object tracking method 6 are described in detail above.

A third embodiment of the present invention is a non-transitory computer-readable medium storing instructions that, when executed by a processor, perform the object tracking method 6 described above for the second embodiment. The non-transitory computer-readable medium may be stored in a non-transitory tangible machine-readable medium, such as, but not limited to, a Read-Only Memory (ROM), a Flash Memory, a floppy disk, a mobile hard disk, a magnetic tape, a database that may be connected to the Internet, or any other storage medium with the same function and well known to those of ordinary skill in the art.

According to the above description, the present invention provides a novel, efficient and accurate tracking framework based on Transformer. Considering the speed, robustness and accuracy in practical applications, the present invention designs a concise tracking network, which combines lightweight trunk variants and a simple feature fusion mechanism to achieve a good balance between speed and accuracy. In order to realize object tracking by only using RGB images, the present invention combines the monocular depth estimation network with the tracking network. According to the experimental results, the tracker provided by the present invention has achieved the best tracking results in a plurality of benchmark tests, and surpassed the second best tracker by more than 5.9%. In addition, the tracker of the present invention realizes real-time tracking on the embedded system. Finally, the object tracking network achieves an accuracy of 97.9% on the self-defined data set of the present invention.

The above disclosure is related to the detailed technical contents and inventive features thereof. People of ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An electronic device for object tracking, comprising:
a storage, being configured to store an area image, a target image and an object tracking network; and
a processor, being electrically connected with the storage, and being configured to construct and execute the object tracking network to confirm a piece of location information of an object represented by the target image in the area image, the object tracking network comprising a feature extraction backbone network, a feature fusion network and a prediction network, and wherein:
the feature extraction backbone network comprises two feature extractors with shared weights, and the two feature extractors are respectively configured to extract features according to the area image and the target image so as to generate a target feature map and an area feature map;
the feature fusion network includes a plurality of cross-attention layers and a channel attention module, wherein each cross-attention layer includes two parallel cross-attention transformer modules, and in the feature fusion network, both the target feature map and the area feature map are input into the two cross-attention transformer modules, and the feature fusion network is configured to: perform a depthwise cross correlation operation on the target feature map and the area feature map that have been refined by the plurality of cross-attention layers, thereby generating a response map;
generate a channel attention vector according to the response map through the channel attention module; and
perform an element-wise multiplication operation on the channel attention vector and the response map to generate a weighted response map; and
the prediction network is configured to generate the position information according to the weighted response map.

2. The electronic device according to claim 1, wherein the storage is further configured to store a depth estimation network, and the processor is further configured to construct and execute the depth estimation network to generate a piece of depth information according to the target image.

3. The electronic device according to claim 2, wherein the depth estimation network comprises an encoder, a non-local block, and a decoder, and the decoder comprises a Squeeze-and-Excitation module.

4. The electronic device according to claim 2, further comprising a transport module electrically connected with the processor, and wherein:
the transport module is configured to move the electronic device so that the electronic device follows the object represented by the target image; and
the processor is further configured to determine the moving direction of the transport module according to the position information and determine the moving depth of the transport module according to the depth information.

5. The electronic device according to claim 1, further comprising an audio capturing module, an image capturing module and a transport module, wherein the audio capturing module, the image capturing module and the transport module are all electrically connected with the processor, and the image capturing module is further electrically connected with the storage, wherein:
the audio capturing module is configured to continuously receive sound signals;
the processor is further configured to identify a preset voice command in the sound signals;
the transport module is configured to move the electronic device after the voice command has been identified by the processor, so that the image capturing module faces a source of the voice command; and
the image capturing module is configured to photograph the source to generate the area image and the target image.

6. The electronic device according to claim 1, wherein the feature fusion network takes each channel of the target feature map refined by the plurality of cross-attention layers as a convolution kernel, and performs cross correlation operation on each corresponding channel of the area feature map refined by the plurality of cross-attention layers to generate the response map after depthwise cross correlation.

7. The electronic device according to claim 1, wherein the feature fusion network performs Max-Pooling operation and Average-Pooling operation respectively on the response map through the channel attention module to generate two different feature space enhancement vectors respectively, sends the two vectors into a multi-layer perceptron network for enhancement, and then performs element-wise addition on the two feature space enhancement vectors that have been enhanced, thereby generating the channel attention vector.

8. The electronic device according to claim 1, wherein the multi-layer perceptron network comprises a hidden layer and a Sigmoid function.

9. The electronic device according to claim 1, wherein the prediction network comprises a classification branch and a regression branch, both of which are composed of three multi-layer perceptron networks, and wherein:
the classification branch performs foreground and background target classification on the target response map fused by the feature fusion network and generates a classification vector; and
the regression branch is configured to predict the position and size of a target center point and generate a regression vector containing the position information.

10. A non-transitory computer-readable medium storing instructions that, when executed by a processor, perform an object tracking method executed by an electronic device, the object tracking method comprising the following steps:
constructing an object tracking network, the object tracking network comprising a feature extraction backbone network, a feature fusion network and a prediction network, and wherein:
the feature extraction backbone network comprises two feature extractors with shared weights, and the two feature extractors are respectively configured to extract features according to an area image and a target image so as to generate a target feature map and an area feature map;
the feature fusion network includes a plurality of cross-attention layers and a channel attention module, wherein each cross-attention layer includes two parallel cross-attention transformer modules, and in the feature fusion network, both the target feature map and the area feature map are input into the two cross-attention transformer modules, and the feature fusion network is configured to:
perform a depthwise cross correlation operation on the target feature map and the area feature map that have been refined by the plurality of cross-attention layers, thereby generating a response map;
generate a channel attention vector according to the response map through the channel attention module; and
perform an element-wise multiplication operation on the channel attention vector and the response map to generate a weighted response map; and
the prediction network is configured to generate a piece of position information according to the weighted response map; and
executing the object tracking network to confirm the position information of an object represented by the target image in the area image.

11. The non-transitory computer-readable medium according to claim 10, wherein the object tracking method further comprises the following step: constructing and executing a depth estimation network to generate a piece of depth information according to the target image.

12. The non-transitory computer-readable medium according to claim 11, wherein the depth estimation network comprises an encoder, a non-local block, and a decoder, and the decoder comprises a Squeeze-and-Excitation module.

13. The non-transitory computer-readable medium according to claim 11, wherein the object tracking method further comprises the following step:
moving to follow the object represented by the target image, wherein the electronic device determines the moving direction according to the position information and determines the moving depth according to the depth information.

14. The non-transitory computer-readable medium according to claim 10, wherein the object tracking method further comprises the following steps:
continuously receiving sound signals;
identifying a preset voice command in the sound signals;
moving to make an image capturing module of the electronic device face a source of the voice command after the voice command is identified; and
photographing the source to generate the area image and the target image.

15. The non-transitory computer-readable medium according to claim 10, wherein the feature fusion network takes each channel of the target feature map refined by the plurality of cross-attention layers as a convolution kernel, and performs cross correlation operation on each corresponding channel of the area feature map refined by the plurality of cross-attention layers to generate the response map after depthwise cross correlation.

16. The non-transitory computer-readable medium according to claim 10, wherein the feature fusion network performs Max-Pooling operation and Average-Pooling operation respectively on the response map through the channel attention module to generate two different feature space enhancement vectors respectively, sends the two vectors into a multi-layer perceptron network for enhancement, and then performs element-wise addition on the two feature space enhancement vectors that have been enhanced, thereby generating the channel attention vector.

17. The non-transitory computer-readable medium according to claim 10, wherein the multi-layer perceptron network comprises a hidden layer and a Sigmoid function.

18. The non-transitory computer-readable medium according to claim 10, wherein the prediction network comprises a classification branch and a regression branch, both of which are composed of three multi-layer perceptron networks, and wherein:
the classification branch performs foreground and background target classification on the target response map fused by the feature fusion network and generates a classification vector; and
the regression branch is configured to predict the position and size of a target center point and generate a regression vector containing the position information.

19. An object tracking method executed by an electronic device, comprising the following:
constructing an object tracking network, the object tracking network comprising a feature extraction backbone network, a feature fusion network and a prediction network, and wherein:
the feature extraction backbone network comprises two feature extractors with shared weights, and the two feature extractors are respectively configured to extract features according to an area image and a target image so as to generate a target feature map and an area feature map;
the feature fusion network includes a plurality of cross-attention layers and a channel attention module, wherein each cross-attention layer includes two parallel cross-attention transformer modules, and in the feature fusion network, both the target feature map and the area feature map are input into the two cross-attention transformer modules, and the feature fusion network is configured to:
perform a depthwise cross correlation operation on the target feature map and the area feature map that have been refined by the plurality of cross-attention layers, thereby generating a response map;
generate a channel attention vector according to the response map through the channel attention module; and
perform an element-wise multiplication operation on the channel attention vector and the response map to generate a weighted response map; and
the prediction network is configured to generate a piece of position information according to the weighted response map; and
executing the object tracking network to confirm the position information of an object represented by the target image in the area image.

20. The object tracking method according to claim 19, further comprising the following steps:
continuously receiving sound signals;
identifying a preset voice command in the sound signals;
moving to make an image capturing module of the electronic device face a source of the voice command after the voice command is identified; and
photographing the source to generate the area image and the target image.
